(19) United States
(12) Patent Application Publication
(10) Pub. No.: US 2017/0125986 A1
(43) Pub. Date: May 4, 2017

(54) Cable Accessory Removal Tool

(71) Applicants: Bruce Bier, Warren, NJ (US); Christopher Juillet, Hoboken, NJ (US)

(72) Inventors: Bruce Bier, Warren, NJ (US); Christopher Juillet, Hoboken, NJ (US)

(73) Assignee: RICHARDS MANUFACTURING COMPANY SALES, INC., Irvington, NJ (US)

(21) Appl. No.: 14/930,640

(22) Filed: Nov. 2, 2015

(51) Int. Cl. H02G 1/12; H02G 15/00

(52) U.S. Cl. CPC H02G 1/1217; H02G 15/00

(57) ABSTRACT

A cable accessory removal tool is disclosed. The tool comprises a first handle, a guard member, and a cutting member. The cutting member includes a second handle and a blade that rotates about a pivot point. In a first position, a portion of the blade is positioned within a groove of the guard member. The cutting member is rotated to a second position using the second handle. Various methods of removing a cable accessory without damaging the cable covered by the cable accessory are disclosed.

### FIELD OF INVENTION

The present invention relates to a tool for removing a cable accessory from a power cable used in the field of power distribution.

### BACKGROUND

Cable accessories are used in underground and overhead electrical distribution networks to connect sections of power cables. Generally, such cable accessories are composed of relatively inelastic materials of various types (i.e., rubber and silicone). Some types of rubber cable accessories are installed by pushing the cable accessory over a cable and securing it with an interference fit. As a result, such cable accessories can be easily removed by sliding the cable accessory off the section of the cable.

Cable accessories composed of flexible elastic materials are becoming increasingly common in the industry. Cold shrink cable accessories utilize a support core to keep the cable accessory in an expanded state that is greater than the diameter of the section of cable that the cable accessory connects to. The cable accessory is first placed over the section of cable, and then the support core is removed. The removal of the support core shrinks the elastic housing of the cable accessory over the section of cable to form a tight seal and protect the electrical connection. The elastic housing of the cold shrink cable accessory will continue to tighten over the cable over time based on the inherent physical properties of the elastic material in response to environmental conditions. As a result, it can be difficult to remove cold shrink cable accessories as compared to traditional inelastic cable accessories, due to the tighter fit between the cable accessory housing and the section of cable.

Like cold shrink cable accessories, heat shrink cable accessories are placed over the section of cable in much the same manner as described above. However, in this application, a linesperson applies heat to the heat shrink cable accessory to shrink the housing of the heat shrink cable accessory around the section of cable to create a tighter fit.

Typically, a linesperson will need to reuse terminated pieces of a cable, due to a lack of slack in the cable to create a new termination. As a result, it is common for a linesperson to remove a cable accessory and install a new cable accessory over the same section of the cable. Therefore, it is critical during installations that the linesperson remove cable accessories without damaging the cable to allow for a clean installation.

Typically, cable accessories (i.e. cold shrink, heat shrink, etc.), which are utilized to terminate sections of power cables, are removed by cutting through the housing of the cable accessory. A linesperson commonly utilizes a cutting member comprising a blade and a handle. The process begins with the linesperson holding the handle of the cutting member at a downward angle. Next, the linesperson applies a sufficient downward force to insert the blade of the cutting member through the housing of the cable accessory. Thereafter, the linesperson applies a force generally along the length of the housing of the cable accessory to cut. A disadvantage of using a heat or cold shrink cable accessory is that they are designed to be permanently installed. Therefore, when installing a new cable accessory as described above, the process of removing a heat or cold shrink cable accessory may lead to several issues. First, a linesperson can inadvertently damage or destroy the cable accessory, generally by cutting the accessory with a blade. Such installations allow for error in the field as the linesperson may inadvertently damage the cable by cutting too deep. In addition to damaging the cable, the linesperson can inadvertently injure himself or herself by mishandling the cutting member while cutting along the length of the cable accessory.

Therefore, a need exists in the field for a tool to remove cable accessories without causing damage to the cable or injury to the linesperson.

### BRIEF SUMMARY OF THE INVENTION

The current disclosure provides for a cable accessory removal tool and method to protect the cable from damage. The tool is designed to also protect the linesperson from injury during removal of a cable accessory.

The disclosed tool comprises two handles, one that allows the linesperson to push a cutting member between the cable accessory and cable, and a second handle that allows the linesperson to rotate the cutting member upward to cut through the cable accessory. The cutting member can be spring loaded, in order to return the cutting member to a first position. In addition, the tool includes a guard member to prevent the cutting member from contacting the cable during the removal process.

The disclosed cable accessory removal tool can be utilized for removing cable accessories, including but not limited to, cold shrink, heat shrink, and conventional push on (interference fit) cable accessories.

### BRIEF DESCRIPTION OF THE DRAWINGS

The detailed description makes reference to the accompanying figures wherein:

FIG. 1 illustrates a perspective view of a cable accessory removal tool according to the preferred embodiment of the present invention;

FIG. 2 illustrates a side view of the tool shown in FIG. 1 with the cutting member in a first position;

FIG. 3 illustrates a side view of the tool shown in FIG. 1 with the cutting member in a second position;

FIG. 4 illustrates a cross-sectional side view of the tool shown in FIG. 1 with the cutting member in a first position;

FIG. 5 illustrates a cross-sectional side view of the tool shown in FIG. 1 with the cutting member in a second position; and

FIG. 6 illustrates a side view of an exemplary tool in accordance with the principles of the present invention.

Other objects, features, and characteristics of the present invention, as well as methods of operation and functions of the related elements of the structure and the combination of parts, will become more apparent upon consideration of the following detailed description with reference to the accompanying drawings.

### DETAILED DESCRIPTION OF THE PREFERRED EMBODIMENT

A detailed illustrative embodiment of the present invention is disclosed herein. However, techniques, methods, processes, systems, and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure.

None of the terms used herein, including “member,” “tool,” “cable,” and “cable accessory” are meant to limit the application of the invention. The terms merely explain the invention disclosed by illustrating the preferred embodiment and are not intended to limit the scope of the invention. Similarly, the use of these terms is not meant to limit the scope or application of the invention, as the invention is versatile and can be utilized in many applications, as will be apparent in light of the disclosure set forth herein.

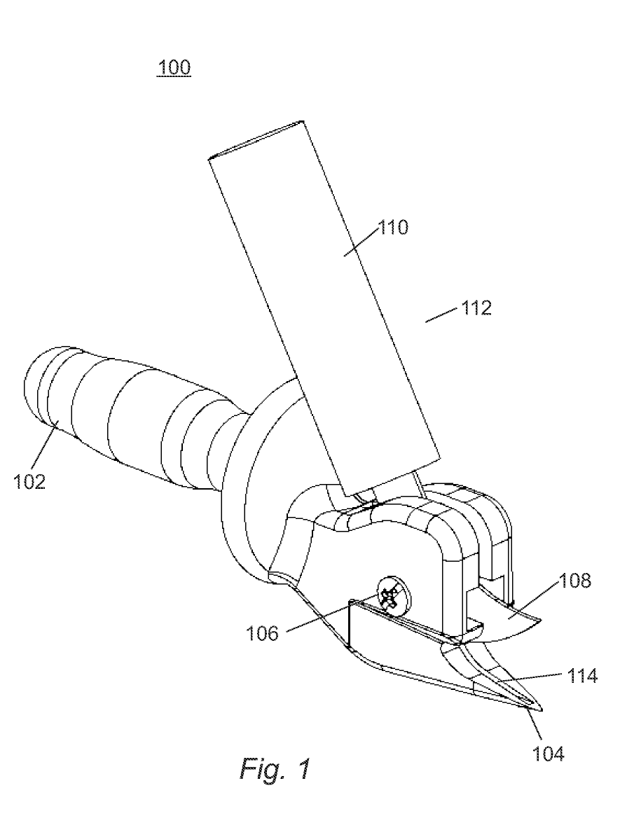

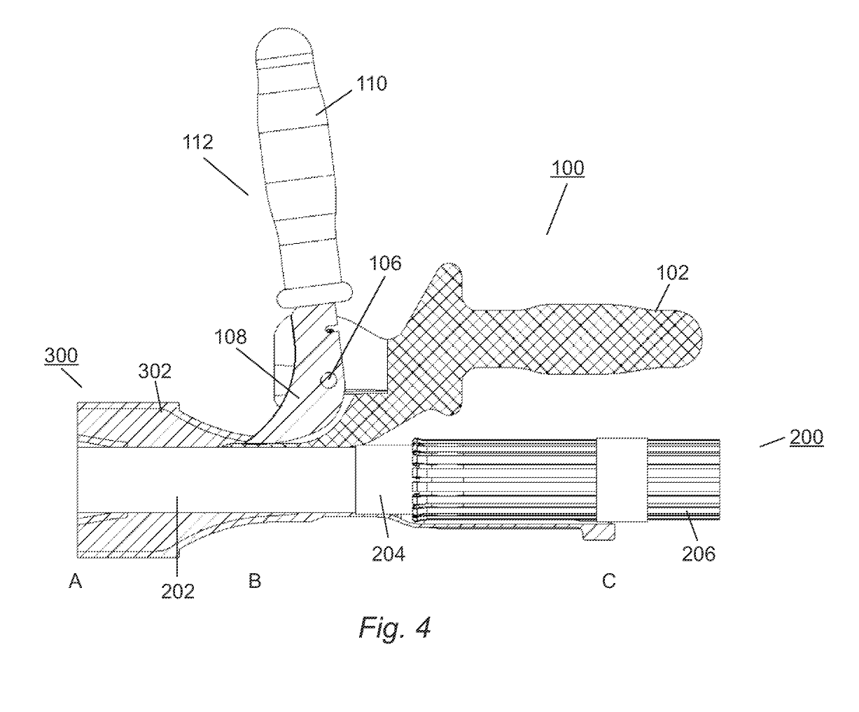

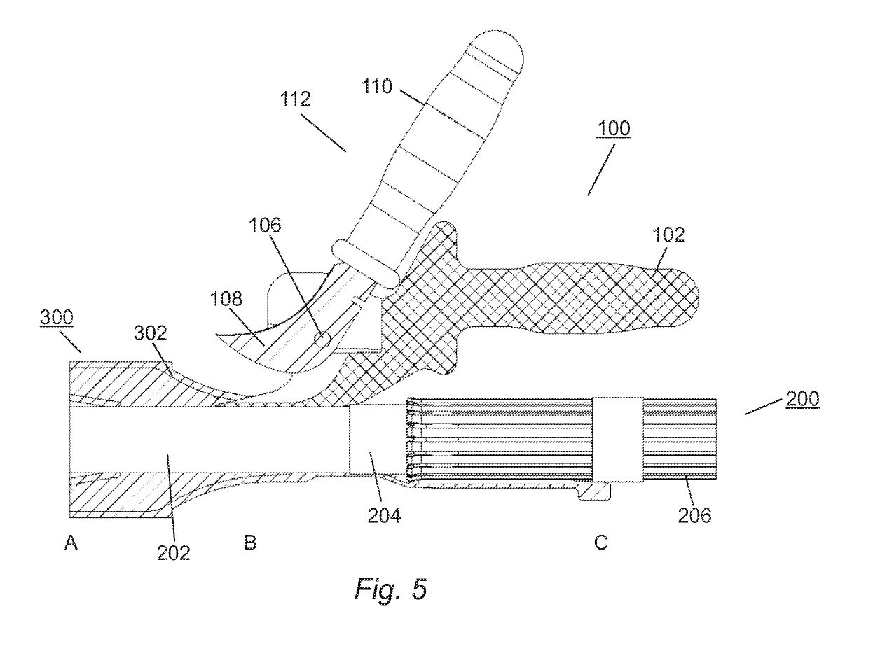

Referring initially to FIG. 1, shown is tool 100 in accordance with the preferred embodiment of the present invention. Tool 100 comprises first handle 102 and guard member 104. As shown in FIG. 1, guard member 104 is generally V-shaped and includes an upward curving incline. As described in further detail below with reference to FIG. 4 and FIG. 5, this design facilitates the insertion of guard member 104 between a cable accessory and a cable that is coupled to the cable accessory. One of ordinary skill in the art will readily recognize that other shapes can be utilized for guard member 104 without departing from the spirit of the present invention. Guard member 104 includes groove 114.

Tool 100 further includes cutting member 112. Cutting member 112 comprises second handle 110 and blade 108. While a hook shape is depicted for blade 108, one of ordinary skill in the art will readily recognize that other shapes could be employed such as a triangular shape. Cutting member 112 rotates about pivot point 106. As shown in FIG. 1, cutting member 112 is rotated to a second position. In the second position, blade 108 is not positioned within groove 114 of guard member 104. Further, in the preferred embodiment, cutting member 112 includes a spring loaded mechanism to rotate cutting member 112 to a first position when a sufficient force is not applied to second handle 110. It would be apparent to one of ordinary skill in the art to utilize other known mechanisms to rotate the cutting member to a first position.

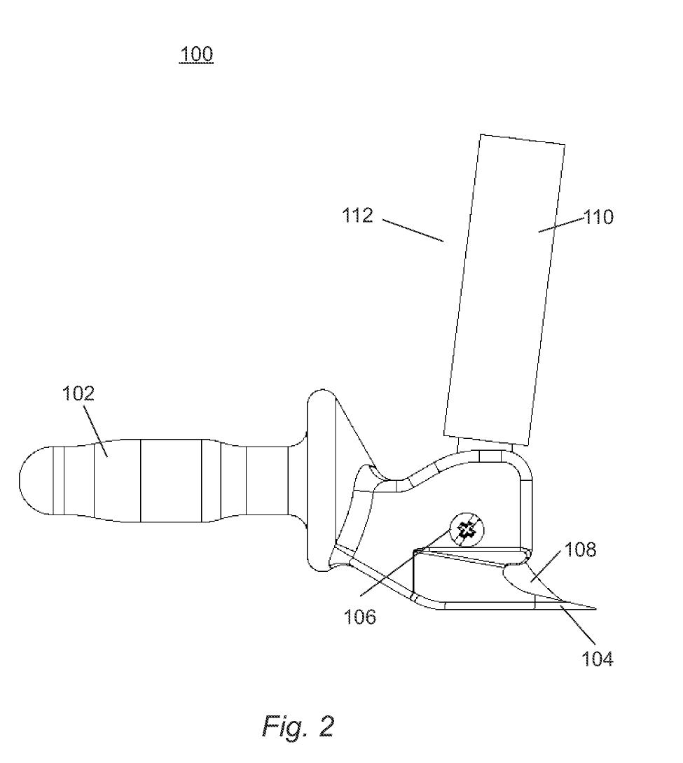

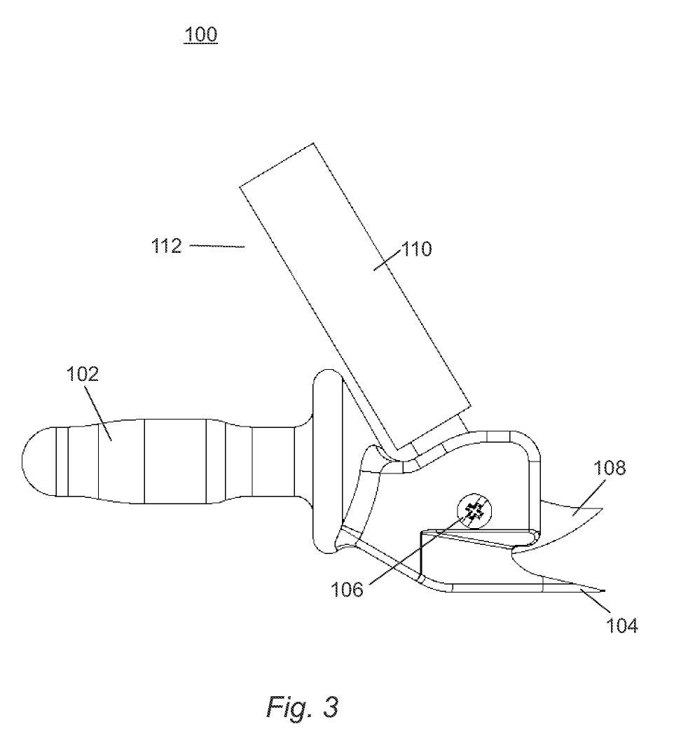

Turning now to FIG. 2, shown is cutting member 112 in a first position. In the first position, blade 108 is moved within the groove (not shown) of guard member 104. A portion of blade 108 is exposed to allow blade 108 to cut the housing of a cable accessory as guard member 104 is inserted between a cable accessory and cable that is coupled to the cable accessory. FIG. 3, depicts cutting member 112 in a second position. In the second position, blade 108 is positioned outside of the groove (not shown) of guard member 104. During installation, a linesperson rotates cutting member 112 about pivot point 106 to the second position in order to assist with cutting the housing of a cable accessory.

Referring to FIG. 4 and FIG. 5, shown is the process of utilizing tool 100 to remove cable accessory 300 from a prepared cable end 200. Prepared cable end 200 comprises an outer jacket (not shown), neutral wires 206, extruded shield 204, cable insulation 202, and a cable conductor (not shown). Typically, a prepared cable 200 is created by removing the outer cable jacket (not shown) and folding back the neutral wires 206 from the extruded shield 204. Extruded shield 204 is also removed to partially expose cable insulation 202. Furthermore, cable insulation 202 is removed to expose the cable conductor (not shown). Although a jacketed concentric neutral cable is depicted in FIG. 4 and FIG. 5, the present invention is not limited to such a cable. One skilled in the art should readily understand that other cable constructions such as jacketed drain, lead jacketed, copper tape shielded, and the like may be utilized with the component of the present invention without departing from the spirit of the invention as disclosed.

As shown, cable accessory 300 comprises a housing 302 that covers a portion of the outer jacket (not shown), neutral wires 206, extruded shield 204, cable insulation 202, and the cable conductor (not shown) of prepared cable 200. The thickness of housing 302 can vary between section A to section B, and between section B to section C of housing 302 depending on the particular cable accessory. In FIG. 4, cutting member 112 is positioned in a first position. In order to make the desired incision, a linesperson grasps first handle 102 and inserts an end of guard member 104 between housing 302 and prepared cable 200. Thereafter, the linesperson applies a force along the length of housing 302 by inserting tool 100 along section C to section B of housing 302. As shown, the linesperson positions blade 108 within groove 114 of guard member 104. While a portion of blade 108 is exposed to cut housing 302, blade 108 is substantially positioned above the bottom surface of guard member 104. As a result, guard member 104 prevents blade 108 from making contact with cable insulation 202, extruded shield 204, neutral wires 206, and the outer jacket (not shown) of prepared cable end 200, as tool 100 is inserted along section C to section B of housing 302.

In FIG. 5, cutting member 112 is positioned in a second position. In the preferred embodiment, a linesperson rotates cutting member 112 about pivot point 106 to the second position by grasping second handle 110. As cutting member 112 rotates, blade 108 cuts the thicker portion in section A to section B of housing 302. Thereafter, the linesperson can return cutting member 112 to the first position shown in FIG. 4. The linesperson repeats the steps of applying a force along the length of the housing with the first handle and rotating cutting member 112 with second handle 110 in order to cut along section A to section B of housing 302 without damaging cable insulation 202. In addition, it is evident from the above description of operation that the safety features of tool 100 prevent injury to the linesperson during use.

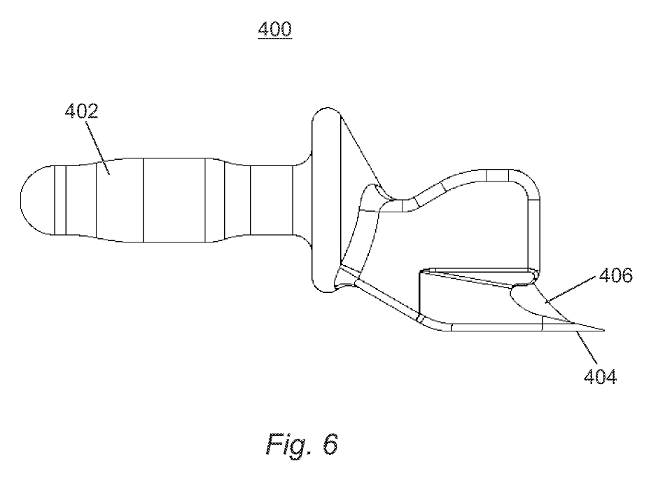

Referring now to FIG. 6, tool 400 depicts an embodiment of the present invention. Tool 400 comprises first handle 402 and guard member 404. Guard member 404 is generally V-shaped and includes an upward curving incline. Cutting member 408 comprises blade 406. As shown, blade 406 is positioned in a groove (not shown) of guard member 404. Further, blade 406 is positioned above the bottom surface of guard member 404. As a result, guard member 404 prevents blade 406 from making contact with the cable insulation of a cable as tool 400 is inserted to cut the housing of a cable accessory.

While the present invention has been described with reference to the preferred embodiment, which has been set forth in considerable detail for the purposes of making a complete disclosure of the invention, the preferred embodiment is merely exemplary and is not intended to be limiting or represent an exhaustive enumeration of all aspects of the invention. It will be apparent to those of skill in the art that numerous changes may be made in such details without departing from the spirit and the principles of the invention. It should be appreciated that the present invention is capable of being embodied in other forms without departing from its essential characteristics.

What is claimed is:

1. A method of removing a cable accessory from a cable, comprising the steps of:
inserting a guard member of a tool between a housing of a cable accessory and a cable;
applying a force substantially along the length of the housing; and
cutting along the length of the housing with a cutting member of the tool.

2. The method of claim 1, further comprising the step:
sliding a bottom surface of the guard member on the cable.

3. The method of claim 1, further comprising the steps:
rotating the cutting member; and
cutting upward into the housing of the cable accessory.

4. The method of claim 3, wherein the step of cutting upward into the housing of the cable accessory further comprises the step:
cutting along an upward arc path into the housing of the cable accessory.

5. The method of claim 3, further comprising the steps of:
holding a first handle of the tool to apply the force substantially along the length of the housing; and
holding a second handle of the tool to rotate the cutting member about a pivot point.

6. A cable accessory removal tool, comprising:
a first handle;
a cutting member; and
a guard member.

7. The cable accessory removal tool of claim 6, wherein the cutting member comprises:
a second handle; and
at least one blade.

8. The cable accessory removal tool of claim 7, wherein the blade is hooked shaped.

9. The cable accessory removal tool of claim 6, wherein the guard member comprises at least one groove.

10. The cable accessory removal tool of claim 6, wherein the guard member is substantially v-shaped and includes an upward curving incline.

11. The cable accessory removal tool of claim 6, further comprising a pivot point wherein the cutting member rotates about the pivot point.

12. The cable accessory removal tool of claim 6, further comprising a return mechanism attached to the cutting member.

13. A cable accessory removal tool, comprising:
a first handle;
a cutting member comprising:
a second handle, and
at least one blade; and
a guard member comprising:
at least one groove.

14. The cable accessory removal tool of claim 13, further comprising a return mechanism attached to the cutting member.

15. The cable accessory removal tool of claim 14, wherein the return mechanism comprises a spring.

16. The cable accessory removal tool of claim 13, wherein the cutting member further comprises:
a first position; and
a second position.

17. The cable accessory removal tool of claim 16, wherein the blade of the cutting member is positioned within the groove of the guard member in the first position.

18. The cable accessory removal tool of claim 16, further comprising a pivot point wherein the cutting member rotates about the pivot point to the second position.

19. The cable accessory removal tool of claim 16, wherein the guard member is substantially v-shaped and includes an upward curving incline.

20. The cable accessory removal tool of claim 16, wherein the blade is hooked shaped.
